(19) United States
(12) Patent Application Publication
(10) Pub. No.: US 2009/0089121 A1
(43) Pub. Date: Apr. 2, 2009

(54) Method and system for controlling a project

(75) Inventors: Christian Korner, Bergen (DE); Stephan Storck, Monmouth Jct, NJ (US)

Correspondence Address: HARNESS, DICKEY & PIERCE, P.L.C., P.O.BOX 8910, RESTON, VA, 20195, US

(73) Assignee: SIEMENS AKTIENGESELLSCHAFT

(21) Appl. No.: 12/068,061

(22) Filed: Feb. 1, 2008

Related U.S. Application Data
(60) Provisional application No. 60/960,393, filed on Sep. 27, 2007.

(51) Int. Cl. G06Q 10/00

(52) U.S. Cl. 705/7; 705/1

(57) ABSTRACT

A method and a system are disclosed for controlling a project for the provision of a product. In at least one embodiment, project data of the project is assigned to a product structure of the product and, depending on the project data which is assigned to the product structure, the control of the project takes place in an automated manner.

### PRIORITY STATEMENT

The present application hereby claims priority under 35 U.S.C. §119(e) on U.S. patent application No. 60/960,393 filed Sep. 27, 2007, the entire contents of which is hereby incorporated herein by reference.

### FIELD

Embodiments of the invention generally relate to a method and/or a system for controlling a project for the provision of a product, for example a software product.

### BACKGROUND

Projects for providing or manufacturing a product, e.g. software development projects, are difficult for a project manager to control or supervise, since the products are complex and the project manager receives a multiplicity of different information from different fields in different presentation variants. Examples of information received by a project manager in relation to a project include the costs incurred to date, the remaining budget, the time that remains for implementing project parts, or the availability of resources, e.g. human resources, relative to time. A project manager also receives statistics from various development processes, information relating to outstanding risks and to the quality status of the product.

The control or supervision of a project is difficult because of the large quantity of heterogeneous information. The control of the project is also difficult because information relating to different projects is forwarded to the project manager from various employees in different presentation variants. For example, a project manager receives information in the form of tables, bar graphs, histograms or flow diagrams. The project control is not usually geared towards the result of the project in this case, but the data is presented from the perspective of different disciplines.

Using conventional project control methods, therefore, the project manager receives a multiplicity of different information in heterogeneous form. The project manager then makes decisions intuitively and initiates corresponding measures by means of instructions to employees who are responsible for various project parts. As a result of the intuitive or subjective decision of the project manager, therefore, incorrect measures are undertaken or essential measures are omitted in many projects.

### SUMMARY

In at least one embodiment, the present invention therefore addresses the problem of establishing a method and/or a system for controlling a project for the provision of a product, wherein the control takes place in an automated manner.

This problem is improved upon or even solved in accordance with a method of at least one embodiment of the present invention.

At least one embodiment of the invention establishes a method for controlling a project for the provision of a product, wherein the project data of the project is assigned to a product structure of a product and, depending on the project data which is assigned to the product structure, the control of the project takes place in an automated manner.

In an embodiment of the method according to the invention, a model editor generates at least one integration model and at least one data flow model on the basis of object models of the project which are provided by base systems.

In an embodiment of the method according to the invention, the model editor takes the form of a UML editor.

In an embodiment of the method according to the invention, filter generators generate an integration scheme for an integration database from the integration and data flow models.

In an embodiment of the method according to the invention, the filter generators generate extraction filters for extracting project-relevant data from the base system, and the extracted project-relevant data is stored in the integration database.

In an embodiment of the method according to the invention, the filter generators generate integration filters for the integration of project data in the integration database.

In an embodiment of the method according to the invention, the extraction filters and the integration filters take the form of plug-in filter programs.

In an embodiment of the method according to the invention, a selection editor for selecting filter parameters for presentation filters is automatically generated from the integration scheme.

In an embodiment of the method according to the invention, a project manager selects filter parameters for a selection filter by means of the generated selection editor and depending on an application scenario (use case).

In an embodiment of the method according to the invention, on the basis of the selected filter parameters, the project data is provided for presentation filters by way of selection filters.

In an embodiment of the method according to the invention, the presentation filters output the integrated project data, which has been structured according to the product structure, in a selectable destination data format.

In an embodiment of the method according to the invention, the project data which has been structured according to the product structure is output by the presentation filters as a PowerPoint file, a web graphics file, a web document or a virtual reality model.

In an embodiment of the method according to the invention, the selection filters and the presentation filters take the form of a plug-in filter program in each case.

In an embodiment of the method according to the invention, rules are defined for the integrated project data in connection with the product structure.

In an embodiment of the method according to the invention, a check determines whether rules are violated.

In an embodiment of the method according to the invention, if a rule is violated, modification requirements (change requests) or procedural instructions (activities) are generated for those having responsibility for the product parts.

At least one embodiment of the invention further establishes a system for controlling a project for the provision of a product, wherein project data of the project is assigned to a product structure of the product and, depending on the project data which is assigned to the product structure, the control of the project takes place in an automated manner.

### BRIEF DESCRIPTION OF THE DRAWINGS

Example embodiments of the inventive method and the inventive system for controlling a project for the provision of a product are described below with reference to the appended figures for explaining essential features of embodiments of the invention, in which:

FIG. 1 shows a diagram for illustrating an example of a hierarchically structured software product;

FIG. 2 shows the generation of an integration model and a data flow model in an embodiment of the system according to the invention;

FIG. 3 shows the generation of integration filters and extraction filters in an embodiment of the method according to the invention;

FIG. 4 shows the generation of an integrated project view in an embodiment of the method according to the invention;

FIG. 5 shows the automatic generation of presentations of the project in an embodiment of the method according to the invention;

FIG. 6 shows an example of a product structure as an application example of an embodiment of the inventive method for controlling a software development project;

FIG. 7 shows examples of base systems which are used in an embodiment of the inventive method for controlling a project;

FIG. 8 shows an example of a data flow model such as that used in the method according to an embodiment of the invention.

### DETAILED DESCRIPTION OF THE EXAMPLE EMBODIMENTS

The terminology used herein is for the purpose of describing particular embodiments only and is not intended to be limiting of the present invention. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In describing example embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

Referencing the drawings, wherein like reference numerals designate identical or corresponding parts throughout the several views, example embodiments of the present patent application are hereafter described. Like numbers refer to like elements throughout. As used herein, the terms “and/or” and “at least one of” include any and all combinations of one or more of the associated listed items.

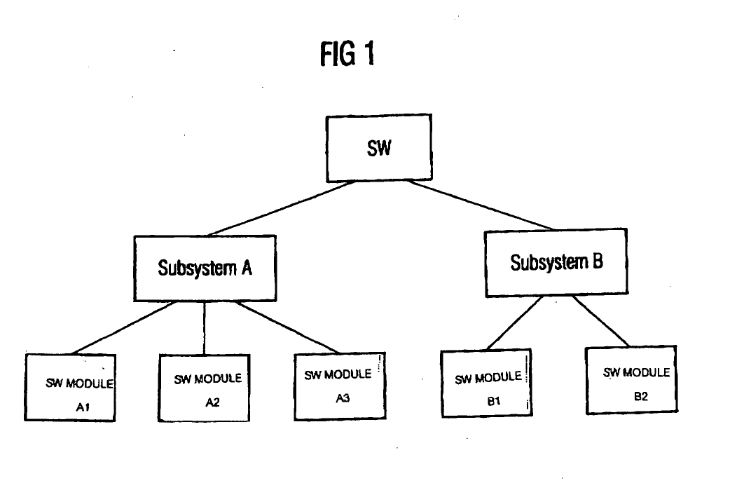

FIG. 1 shows that a complex product, in particular a software product, has a product structure. In the case of the example embodiment illustrated in FIG. 1, the software or software architecture of the software product has a hierarchical structure. Other products, in particular software products, can have other structures which are not necessarily hierarchical, e.g. a matrix-type structure.

In the example embodiment given in FIG. 1, the software product has two subsystems A, B which are in turn formed from a plurality of software modules. In the case of a possible software development project for developing a software product, each software module is developed by an associated team of project employees. In this case, each team of software developers develops source code for the assigned software module. In this case, it is difficult for a project manager who is responsible for the software product development to understand the software code or source code which is produced in this way. In this case, one of the subsystems or software modules can include several thousands of lines of code (LOC).

The project employees supply project data for their respective subprojects to the project manager, wherein the project data of the project is assigned to the product structure of the product in the method according to an embodiment of the invention. Project data which is generated for the software module A1, for example, is assigned to the software module A1 in the method according to an embodiment of the invention. Depending on the project data which is assigned to the product structure, the control of the project then takes place in an automated manner.

In the method according to an embodiment of the invention, the structure of the product or of a complete product family is used for the purpose of automatically mapping the multiplicity of project information, and the time-relative profile thereof, onto comprehensible units. For this, different views of the project are modeled, and an integrated view is mapped or filtered using a data flow graph. Additional presentation filters can be provided in order to produce an attractive presentation of the project. Using the method according to an embodiment of the invention, it is also possible to supervise the status of each component or software module in respect of multiple properties in order to initiate measures in relation to an existing or anticipated subproject result.

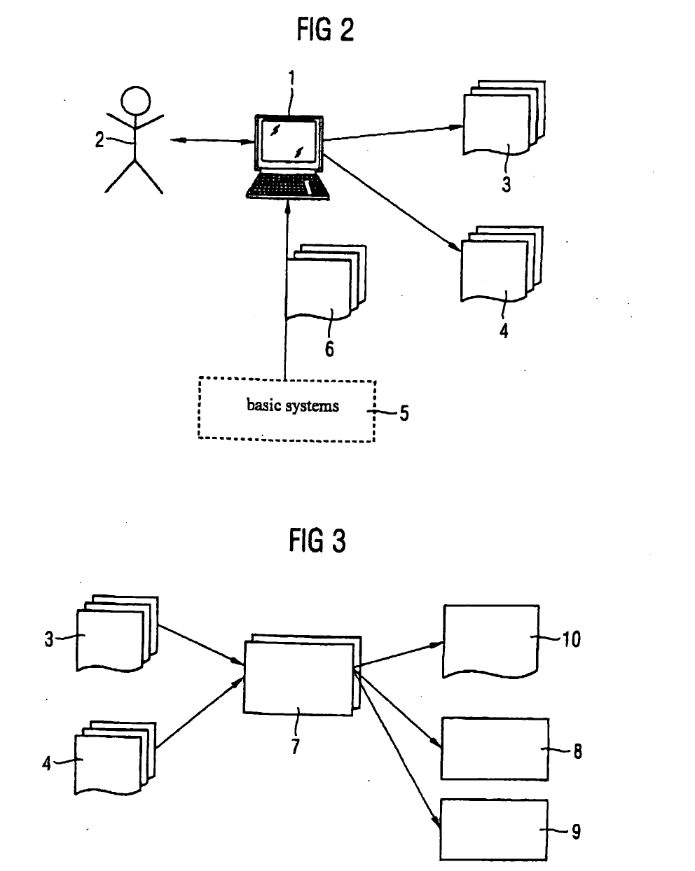

FIG. 2 shows a diagram for illustrating the manner in which an integration model and a data flow model are generated when using an embodiment of the inventive method for controlling a project.

The system according to an embodiment of the invention includes a model editor 1 having the form of a UML editor, for example. The model editor 1 is used by an integrator 2 for the purpose of generating integration models 3 and data flow models 4. In this case, integration models 3 represent the object models, which are modeled using UML, of base systems 5. The data flow models 4 describe transformation graphs for mapping between the individual models and levels. The UML editor 1 can take the form of a standalone application. The UML editor 1 receives object models 6 of the base systems 5.

The base systems 5 can include base systems from different categories. The base systems can be ERP systems or code analysis tools, for example. One possible ERP system is the ERP system from SAP, for example. This ERP base system can be specially configured for a software development company. Data which is stored in a relational database (e.g. an Oracle database) can be input into a correspondingly configured ERP system. Another base system 5 is e.g. a code analysis software tool for static or dynamic analysis of software modules. For example, files are supplied containing code lines in which a coding rule is violated. For example, a field index i which is used in a data array is not allowed to be negative in a programming language.

The code analysis tool specifies the program line in which the relevant coding rule was violated, wherein provision is preferably also made for specifying which coding rule was violated. Moreover, the code analysis tool can indicate the seriousness of the rule violation. The data which is supplied by the base systems 5 can include commercial or technical project data. In addition to ERP systems and code analysis tools, examples of base systems 5 for project management also include Requirements, Change & Defect Management systems, Project Control and Workflow Management systems, and Architecture and Design tools. Further examples of base systems include Version, Configuration and Build Management systems, which produce executable product components from the various software sources.

As illustrated in FIG. 3, the integration models 3 and data flow models 4 produced by the model editor 1 are supplied to filter generators 7. From the integration models 3 and the data flow models 4, the filter generators 7 generate integration filters 8 for integrating project data in an integration database 11. Furthermore, the filter generators 7 generate extraction filters 9 for extracting project-relevant data from the base system 5, wherein the extracted project-relevant data is stored in the integration database 11. Furthermore, the filter generators 7 generate an integration scheme 10 for the integration database.

In a possible embodiment, the filter generators 7 take the form of a plug-in filter program. The extraction filters and integration filters 8, 9 can also take the form of plug-in filter programs in a possible embodiment. The integration scheme 10 features various entities or units, for example. Examples of entities include: project, personnel, class, method, violation.

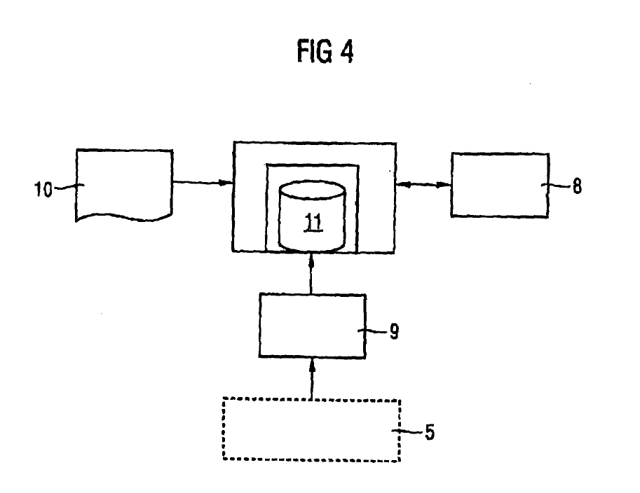

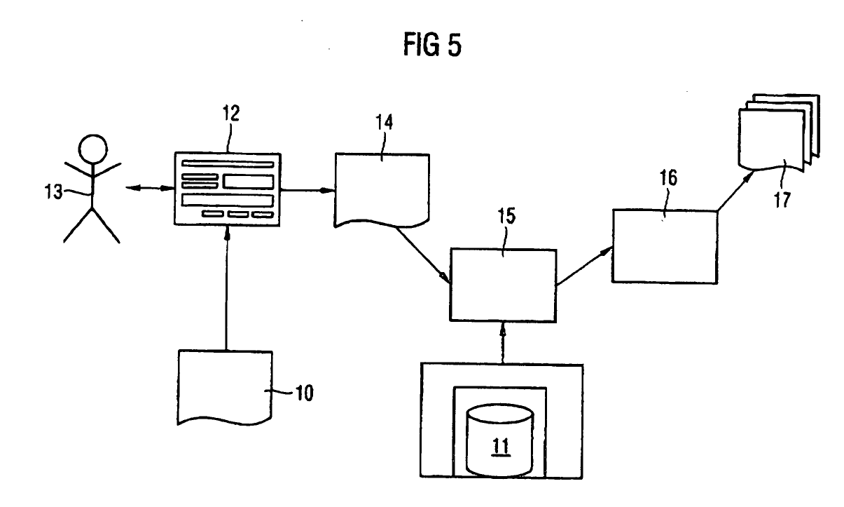

FIG. 4 shows the automatic or automated generation of an integrated project view of the method according to an embodiment of the invention. The integration scheme 10 which is generated by the filter generators 7 is supplied to the integration database 11. The integration database 11 can be designed as an object-oriented or object-relational database. As input data, the integration database 11 receives the integration scheme 10, the data which is filtered by the extraction filters 9, and results of the integration filters 8. The extraction filters 9 filter data which is supplied by the base systems 5 or extract data from the base systems 5. The extraction filters 9 receive object models of the base systems 5 as input. As output data, the data flow models supply data which is entered into the integration database 11.

FIG. 5 illustrates the automatic or automated generation of presentations in the system according to an embodiment of the invention.

A selection editor 12 for selecting filter parameters for presentation filters is automatically generated from the integration scheme 10. The selection editor 12 contains available attributes which are derived from the integration models in the database and the integration scheme 10. The editor content or dialog is preferably generated automatically in this case. The selection editor 12 preferably has a graphical user interface.

A project manager 13 selects filter parameters 14 for a selection filter 15 by way of the generated selection editor 12 depending on an application scenario (use case). The filter parameters 14 can be, for example, all costs and all data changes relating to a subsystem A of a software product in one week, e.g. in the week KW 37. On the basis of the selected filter parameters, project data for the presentation filter 16 is provided by the selection filters 15.

The presentation filters 16 output the integrated project data, which has been structured according to the product structure, in an output document having a selectable destination data format. The project data which has been structured according to the product structure is output by the presentation filters 16 in the form of PowerPoint files, a web graphics file, a web document or a virtual reality model. The selection filters 15 and the presentation filters 16 take the form of plug-in filter programs in a possible embodiment of the system according to an embodiment of the invention. The selection filters 15 and the data (filter parameters) which is selected for presentation by a user from the integration database 11 forward it to the presentation filters 16. As output, the selection filters 15 supply data records which are read out of the integration database 11.

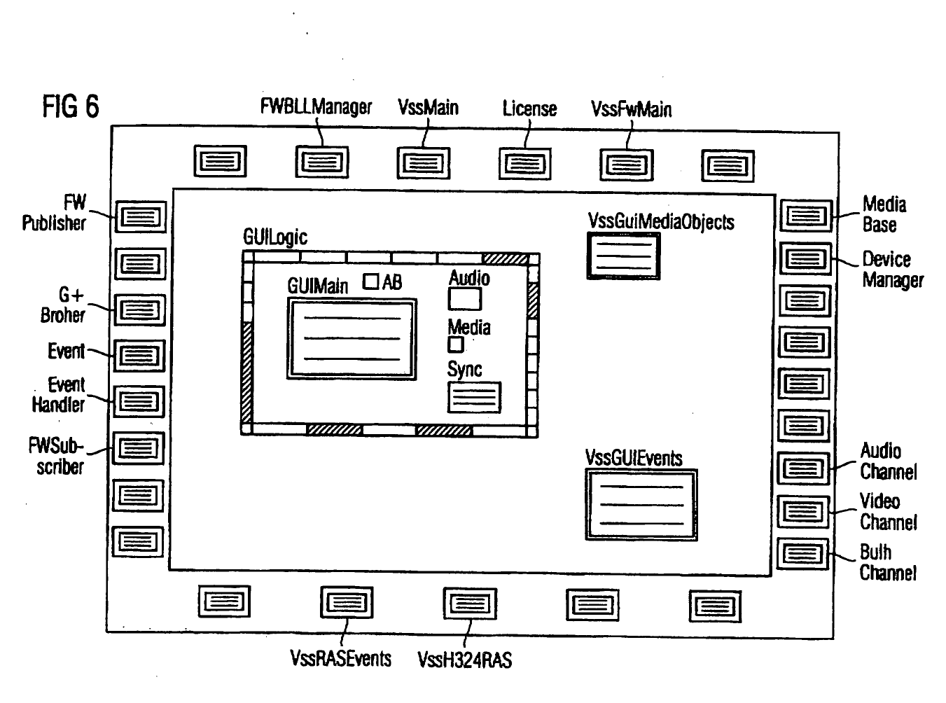

FIG. 6 shows an example of a presentation of a framework architecture of a software product, including embedded quality data, by way of a presentation filter 16. The project data of the software development project is presented as assigned to the product structure of the software product which is to be developed.

In the example illustrated in FIG. 6, the software product includes a plurality of modules such as e.g. GUILlogic, VSSGUImediaobjects or VSSGUIevents. Software modules are graphically presented by way of rectangles on the user interface, wherein e.g. the size or surface area of a rectangle or symbol depends on the size of the software module or the number of lines of code in said software module. The larger the rectangle for a software module, the more lines there are to be encoded in the software module. Furthermore, various hierarchical levels of the module can be presented as subsystems of the respective module within the rectangle of the software module. In the example given, the software module GUILlogic contains various submodules such as e.g. GUImain, AB, Stillimage, Audio, Media, SYNC. Processing services are specified at the frame of the tools. These provide a service for processing a software module.

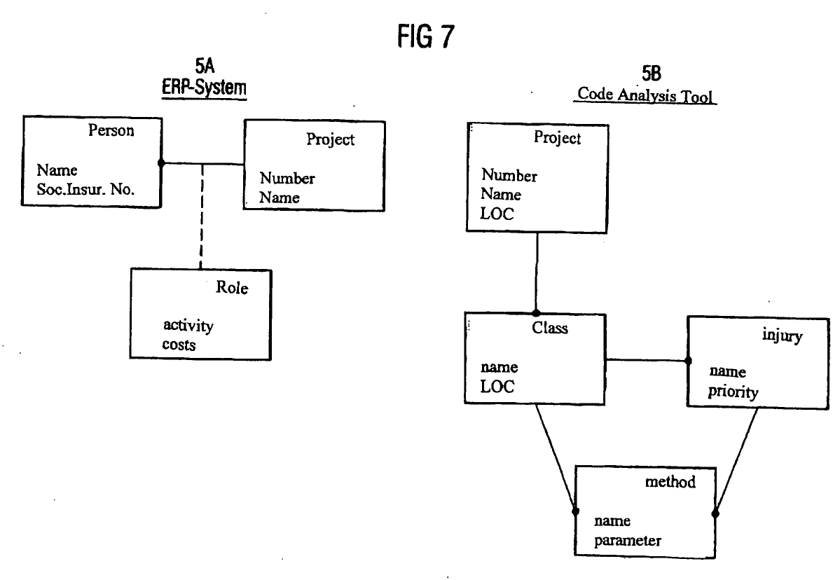

FIG. 7 shows an application example embodiment of the inventive method for controlling a project. Two base systems 5a, 5b are provided in the given example. The first base system 5a is an ERP system which delivers commercial project data in technical form. The second base system 5b is a code analysis tool which delivers technical project data.

In the example embodiment illustrated in FIG. 7, the Entity Relation Model (ERM) comprises a plurality of entities or units. In the given example, an entity “person” is linked to an entity “project” via a relation or relationship. The entity “person” features the name and the social security number of the person as attributes. The entity “project” features a number and a name of a project as attributes. A relation “role”, having the attributes activity and costs, exists between the two entities.

As a further base system 5, the code analysis tool is likewise illustrated as a UML model. The code analysis tool contains “project”, “class”, “method” and “violation” as entities or units. These have attributes in each case.

The entity “project” features a name and an LOC (lines of code) or the code quantity as attributes. The entity “project” is linked to the entity “class” via a relation which does not have attributes. The entity “class” contains the attributes name and LOC (lines of code). The entity “method” contains name and parameter as attributes. The entity. “violation” contains the attributes name and priority.

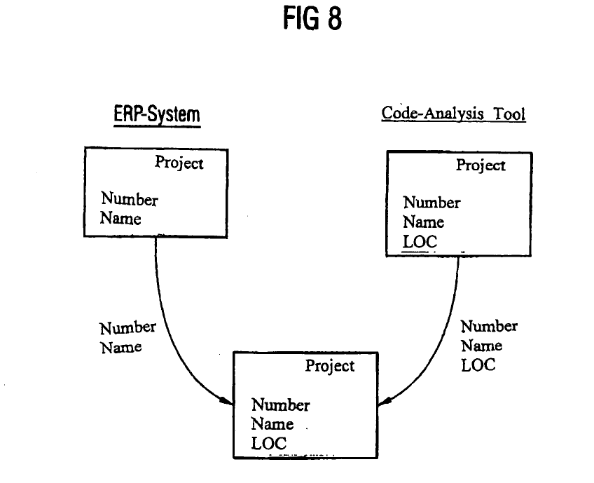

Data is extracted from the base systems 5a, 5b and stored in the integration database 11 with the aid of the extraction filter 9. A data flow model as illustrated by way of example in FIG. 8 is generated on the basis of object models of the project, these being provided by the base systems 5.

An extract from an extraction filter 9 for extracting data from an ERP base system 5a states, for example:

### SELECT* FROM Project WHERE ProjectNr=4711

while (dataset!=END) INSERT INTO Project VALUES ( . . . ).

An example embodiment of an extract from an extraction filter 9 for extracting data from the base system code analysis tool 5b states, for example:

project p=New Project ( . . . );
DataSet ds=p.readproject ( . . . );
for each (ds) INSERT INTO Project VALUES

In an embodiment of the system according to an embodiment of the invention, each base system 5 features an associated extraction filter 9. These extraction filters 9 can feature various languages or database query languages (e.g. SQL or API).

An extract from an integration filters 8 for the example illustrated in the FIGS. 7, 8 states:

Open integration database,
Read costs from project
Read numbers from violation
Apply integration rule
Write data to integration database.

On the basis of the integration scheme 10 including the entities or units personnel, class, method and violation, a selection dialog is generated automatically according to an embodiment of the inventive method.

An extract from a generator script states, for example:

Create dialog
Create field Project name
Create field Budget
Create field Costs
Create field Quality
Create expression editor
Create field OK
Create field Cancel.

On the basis of the attributes selected in the dialog, selection filters are generated in the form of e.g. database instructions. The selection filters fetch the required data from the database and forward it to the presentation filters 16 for presentation of the result:

### SELECT Project.Name, Project.Budget, Person.Name, Violation.Name

### FROM Project, Person, Violation

### WHERE Violation.Class=Class.Name AND Class.Name=Project.Class.

An embodiment of the inventive method for controlling a project for the provision of a product has the significant advantage that a project manager no longer has to compile and present project information manually. Furthermore, processing errors are eliminated. The data relating to the project status and the implemented architecture is precise and correct.

In an example embodiment of the method according to the invention, rules are defined for the integrated project data in connection with the product structure. In this case, a check also determines whether these rules are violated. If a rule is violated, modification requirements (change requests), in particular for a Change & Defect Management system, or procedural instructions (activities), in particular for a Workflow Management system, are generated and provided for those having responsibility for the product parts. The model which is used in the inventive system has its basis in the approach, e.g. in the form of architecture and quality models, allows empirical data to be collected in a structured manner, and hypotheses to be formulated on the basis of the models. These hypotheses can be translated into rules. The formulated rules are tested in various projects.

Modification requirements (change requests) or general work stages (AI) can be generated for the purpose of correcting rule violations. This allows the correction of development errors, particularly in the field of quality and process compliance. In the system according to an embodiment of the invention, UML models of existing base systems 5 for project management can be used for implementing the integration model. In a possible embodiment, UML data flow diagrams are used for integration of the data. As a result of reusing models and mapping structures of various existing projects, standardization can be achieved. An embodiment of the inventive system can be established progressively.

An embodiment of the inventive system maps different perspectives for project management onto results which must be achieved, e.g. the software product or the software product family, in an automated manner. Interrelationships between metrics from different perspectives are therefore clearer for the project manager. Anomalies in interrelationships are likewise visible.

The considerable effort previously required for the integration and presentation of data is eliminated for the project manager. The quality and the presentation of the data are significantly improved as a result of the automated and comprehensible integration. The project manager can therefore check the project status in real time and at shorter intervals. The inventive method allows simple and backwards-compatible modification of a combination or integration of the data.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for controlling a project for the provision of a product, comprising:
assigning project data of the project to a product structure of the product; and
controlling the project in an automated manner, depending on the project data assigned to the product structure.

2. The method as claimed in claim 1, further comprising:
generating, via a model editor, at least one integration model and at least one data flow model on the basis of object models of the project, provided by base systems.

3. The method as claimed in claim 2, wherein the model editor is a UML editor.

4. The method as claimed in claim 2, further comprising:
generating, via at least one filter generator, an integration scheme for an integration database from the at least one integration model and the at least one data flow model.

5. The method as claimed in claim 4, wherein filter generators generate extraction filters for extracting project-relevant data from the base systems, and wherein the extracted project-relevant data is stored in the integration database.

6. The method as claimed in claim 4, wherein filter generators generate integration filters for integrating project data in the integration database.

7. The method as claimed in claim 5, wherein the extraction filters and the integration filters take the form of plug-in filter programs.

8. The method as claimed in claim 1, further comprising:
generating a selection editor, for selecting filter parameters for presentation filters, automatically from an integration scheme.

9. The method as claimed in claim 8, further comprising:
selecting, via a project manager, filter parameters for selection filters by way of the generated selection editor, depending on an application scenario.

10. The method as claimed in claim 9, wherein the project data for presentation filters is provided by selection filters on the basis of the selected filter parameters.

11. The method as claimed in claim 10, wherein the presentation filters output the integrated project data, structured according to the product structure, in a selectable destination data format.

12. The method as claimed in claim 11, wherein the project data structured according to the product structure is output by the presentation filters as at least one of a PowerPoint file, a web graphics file, a web document and a virtual reality model.

13. The method as claimed in claim 10, wherein the selection filters and the presentation filters take the form of a plug-in filter program in each case.

14. The method as claimed in claim 1, wherein rules are defined for the integrated project data in connection with the product structure.

15. The method as claimed in claim 14, wherein a check determines whether rules are violated.

16. The method as claimed in claim 15, wherein if a rule is violated, at least one of modification requirements and procedural instructions are generated for those having responsibility for the product parts.

17. A system for controlling a project for the provision of a product, comprising:
means for assigning project data of the project to a product structure of the product; and
means for controlling, depending on the project data assigned to the product structure, the control of the project in an automated manner.

18. The method as claimed in claim 5, wherein filter generators generate integration filters for integrating project data in the integration database.

19. The method as claimed in claim 18, wherein the extraction filters and the integration filters take the form of plug-in filter programs.

20. A computer readable medium including program segments for, when executed on a computer device, causing the computer device to implement the method of claim 1.

21. A system for controlling a project for the provision of a product, comprising:
a device to assign project data of the project to a product structure of the product; and
a controller to control, depending on the project data assigned to the product structure, the control of the project in an automated manner.
